(19) United States
(12) Patent Application Publication
(10) Pub. No.: US 2001/0031324 A1
(43) Pub. Date: Oct. 18, 2001

(54) Extruded, injection-molded, or blow-molded plastic pipe or fitting for pipelines

(76) Inventor: Gerhard Rosenberg, Attendorn-Ennest (DE)

Correspondence Address: Friedrich Kueffner, 342 Madison Avenue, Suite 1921, New York, NY, 10173, US

(21) Appl. No.: 09/827,706

(22) Filed: Apr. 6, 2001

(30) Foreign Application Priority Data
Apr. 13, 2000 (DE) 100 18 324.7

(51) Int. Cl. B32B 1/08

(52) U.S. Cl. 428/34.7; 264/165; 264/328.1; 264/500

(57) ABSTRACT

An extruded, injection-molded or blow-molded plastic member for pipelines used for transporting liquid, pasty, and gaseous media has a tubular body with an outer layer, an intermediate layer, and an inner layer, wherein the inner layer is in contact with a medium to be transported. The inner layer and the outer layer are made of a basic material and the intermediate layer is made of a basic material and an additional material. The basic material of the inner layer and of the intermediate layer is a polymer material having amorphous areas. Additives against aggressive media are embedded in the amorphous areas of the polymer material of at least one of the inner layer and the intermediate layer. The additional material in the intermediate layer is a barrier material embedded in the amorphous areas of the polymer material of the intermediate layer for reducing additive migration.

### BACKGROUND OF THE INVENTION

1. Field of the Invention

The invention relates to a plastic member in the form of an extruded, injection-molded, or blow-molded pipe, fitting, or shaped part of plastic material for manufacturing pipelines for liquid, pasty, and gaseous media, comprising a tubular body comprised of at least three layers with an inner layer and an outer layer of a basic material and an intermediate layer comprised of a basic material as well as at least one additional material.

2. Description of the Related Art

The aforementioned pipes, fittings, and shaped parts of plastic material are known from European patent document 0 470 605 A1. The field of application for pipes of metal, in particular, copper, galvanized steel, stainless-steel, and, to a minimal extent, also lead, is limited as a result of certain media parameters such as pH value, flow velocities, and operating temperature. The corrosion behavior of metal pipes and the release of heavy metals in the case of lead and copper pipes limit the fields of application of metal pipes for drinking water pipelines and pipelines needed in the foodstuff industry to an even greater degree. Moreover, the production of metals, mining of ore, transport of ore, and smelting of ore as well as the production of metal pipes are in many cases no longer economical as a result of the required energy expenditure and also no longer acceptable with respect to environmental stress.

For the aforementioned reasons, plastic pipes for producing pipelines in different fields of applications, such as drinking water supply, heating technology, the foodstuff industry, apparatus construction, as well as the chemical industry have become more and more important recently.

The advantages of plastic pipes in comparison to metal pipes reside in their greater resistance with respect to aggressive media and incrustations, their improved corrosion resistance, their improved insulating effect, their hygienic suitability, lighter weight, the simpler connecting technology and assembly as well as a more beneficial environmental balance.

The plastic materials employed for producing pipes, such as polyvinyl chloride, un-crosslinked and crosslinked polyethylene, polybutylene, as well as polypropylene, which can be reinforced by inner or outer layers of metal, in particular, aluminum, differ with regard to the employed polymer and the thus resulting different mechanical properties as well as the employed connecting technology. For connecting pipes and shaped parts of plastic, it is conventional to use clamping, screwing, pressing, squeezing, and sliding sleeve systems as well as adhesive systems and heat element socket welding.

The permanent contact with oxidizing and reducing media in pipelines of plastic material deteriorates the chemical and mechanical properties of the plastic material used as a raw material. The macromolecules of the raw material have a certain length and a certain number of intertwined loops. The chain length and the type of intertwined loops primarily determines the properties of the raw material. Between the crystalline components of the polymer materials used preferably as raw materials, non-crystalline, amorphous areas are present which allow a displacement of the crystalline components in the polymer and provide a certain elasticity and tenacity of the raw material.

In order to protect the polymer materials used for the pipes against damage, these amorphous areas can contain additives such as metal deactivators, chlorine scavengers, acid scavengers, radical scavengers, UV stabilizers, processing aids and long-term thermal stabilizers. These additives must be embedded so as to be extraction-stable but must still be able to migrate within the polymer matrix.

The additives are mobile in the amorphous areas of the polymer material. This effect is desirable so that the required additives can migrate to the medium-contacting location where they develop their protective action against the aggressive media and protect the polymer chains against damage.

A decisive disadvantage in the case of pipes of a polymer material with additives is that a considerable amount of the additives migrates via the amorphous areas from the inner layer via the intermediate layer into the outer layer in which the additives are not needed. When the activity of the additives is spent as a result of their protective mechanism or is converted, molecular damage, the so-called chain decomposition, results in the inner layer of the pipes, which are in contact with the medium flowing through the pipes. The raw material becomes brittle, hard, and prone to suffer from cracks or fractures. The wall thickness of the pipes is reduced as a result of abrasion and chain decomposition. Finally, the inner pressure in the pipe causes breakage of the pipe. These decomposition effects of the pipe material are greatly dependent on the medium flowing through and the temperature. With increasing medium temperature the speed at which damage occurs increases more than proportionally.

### SUMMARY OF THE INVENTION

It is an object of the present invention to develop a plastic member in the form of a pipe, a fitting, or a shaped part of plastic material for producing pipelines for liquid, pasty, and gaseous media with a high mechanical, chemical, and thermal resistance and strength.

In accordance with the present invention, this is achieved by multi-layer plastic members in the form of pipes, fittings, and shaped parts of plastic material which are characterized in that the inner layer and the intermediate layer are comprised of a polymer material, in that, in the amorphous areas of the partially crystalline polymer material of the inner layer in contact with the medium to be conveyed and/or of the intermediate layer, additives against aggressive media, in particular, oxidizing and reducing media, are embedded and that in the amorphous areas of the polymer material of the intermediate layer fillers and/or additives as barrier materials are embedded for reducing the migration of the additives from the inner layer into the outer layer of the pipe, the fitting, or the shaped part.

As a result of the barrier effect of the migration-reducing intermediate layer of the pipes, fittings, and shaped parts, the effective additive components remain within the inner layer which comes into contact with the medium flowing through the pipeline. The migration and movement of the additives into layers or areas of the pipes, fittings, and shaped parts which do not come into contact with the medium flowing through the pipeline is prevented. The diffusion of gases and liquids from the exterior through the pipe wall into the medium flowing within the pipeline is also reduced. As a result of the barrier effect of the intermediate layer, the chemical and thermal resistance of the inner layer is increased. As a result of the permanent and continuing concentration of the additives in the inner layer which is in contact with the flowing medium of the pipes, fittings, and shaped parts, the attack of catalytic metal ions and the oxidizing attack by oxygen, acids, and bases as well as of free chlorine and other halogens is successfully counteracted even at higher temperatures, and the resistance against these media is increased. The plastic pipe which is characterized by a layer configuration is also characterized by a higher flexural strength and tensile strength, simple handling and processing, excellent hygienic properties as well as a good sound proofing effect against the flow noises which results from liquid medium flowing through the pipe.

### BRIEF DESCRIPTION OF THE DRAWING

In the drawing:

FIG. 1 is a perspective illustration of a pipe for producing pipelines; and

FIG. 2 is an enlarged cross-sectional illustration of the pipe according to the detail I of FIG. 1.

### DESCRIPTION OF THE PREFERRED EMBODIMENTS

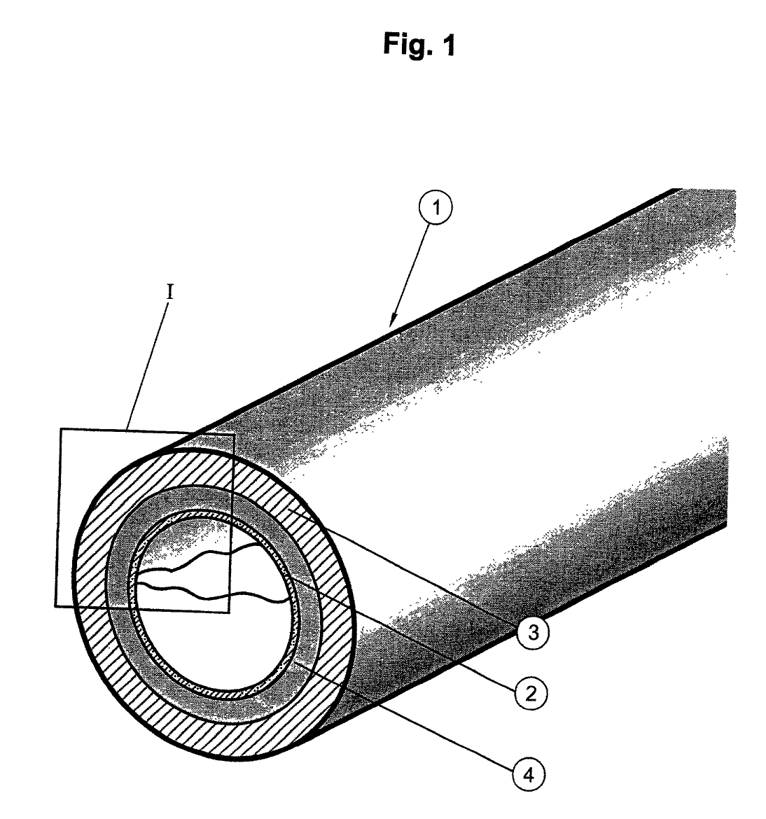

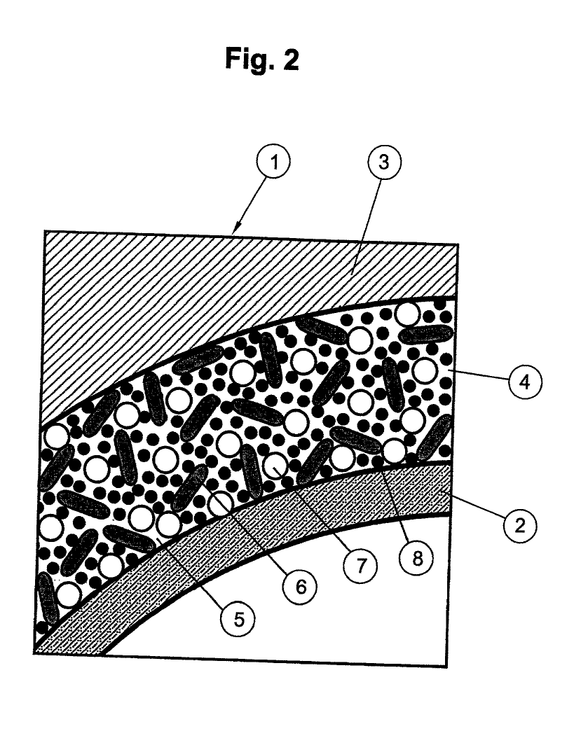

The plastic pipe according to FIGS. 1 and 2 for producing pipelines for liquid, pasty, and gaseous media, which is preferably used as a water pipe and can be preferably produced by extrusion, injection molding or blow molding, has a tubular body 1 which is of a layer configuration with an inner layer 2 and an outer layer 3 of a basic material as well as an intermediate layer 4 of a composite material which is comprised of a basic material and at least one additional material.

The basic material of the inner layer 2 and of the outer layer 3 of the plastic pipe is comprised of polypropylene random copolymer.

The composite material of the intermediate layer 4 of the plastic pipe is comprised of a polypropylene random copolymer 5 with a weight proportion of 50 to 90, preferably 60 to 80, percent by weight, glass fibers 6, glass beads 7, or glass powder 8 or mixtures of these glass components with a weight proportion of 10 to 50, preferably 20 to 40, percent by weight, as well as a bonding agent for bonding the polypropylene random copolymer matrix 5 and the glass fibers 6 and/or the glass beads 7 and/or the glass powder 8 together.

The polypropylene random copolymer of the composite material of the intermediate layer 4 has an ethylene contents of 2 to 6 percent by weight and an MFR (melt flow rate) value of 0.3 to 10 g per 10 minutes at 190° C. and a load of 5 kg.

The bonding agent for bonding the polypropylene random copolymer matrix and the glass fibers, glass beads, or glass powder or mixtures of these glass components of the intermediate layer 4 of the tubular body 1 is a silane compound.

The ethylene is added to the composite material in order to reduce the brittleness resulting from the addition of the fiber material and to provide the material with a sufficient elasticity.

Processing aids, such as internal lubricants, and additives, such as light stabilizing compounds and thermal stabilizing compounds, are mixed into the composite material of the intermediate layer 4 and/or the basic material of the inner layer 2 of the plastic pipe.

For producing the starting composite material of the intermediate layer 4 of the plastic pipe, a plasticized or highly viscous polypropylene random copolymer is processed (mixed) with addition of short glass fibers with an initial length of 0.1 to 6 mm or endless glass fibers, which are comminuted during the mixing process, and/or glass beads and/or glass powder as well as optionally stabilizers and additives to a homogenous composite material, wherein the glass fibers have a tex between 500 to 5,000.

The plastic pipe can be produced in an extrusion machine which is provided with three extrusion devices for extruding the inner layer 2, the intermediate layer 4, and the outer layer 3.

For welding the plastic pipes with fittings or shaped parts, the pipe end to be connected and the inner wall of the bore of the fitting or of the shaped part are heated by a tool to the point of flowing of the plastic material. The tool is in the form of an electrically heated heating sleeve or socket for heating the pipe end and an electrically heated heating mandrel for heating the wall of the bore of the fitting or shaped part. Subsequently, the pipe and fitting are separated from the tool, and the pipe end is inserted into the bore of the fitting so that the two parts are welded together.

The new multi-layer plastic pipe can be used for producing pipelines for liquids, in particular, drinking water lines, as well as gas lines and can be used in the chemical industry, in apparatus construction as well as the foodstuff industry.

While specific embodiments of the invention have been shown and described in detail to illustrate the inventive principles, it will be understood that the invention may be embodied otherwise without departing from such principles.

What is claimed is:

1. An extruded, injection-molded or blow-molded plastic member for pipelines used for transporting liquid, pasty, and gaseous media, the plastic member comprising:
a tubular body comprised of an outer layer, an intermediate layer connected radially inwardly to the outer layer, and an inner layer connected radially inwardly to the intermediate layer, wherein the inner layer is in contact with a medium to be transported;
wherein the inner layer and the outer layer are comprised of a basic material and the intermediate layer is comprised of a composite material of a basic material and an additional material, wherein the basic material of the inner layer and of the intermediate layer is a polymer material, wherein the polymer material comprises amorphous areas;
additives against aggressive media embedded in the amorphous areas of the polymer material of at least one of the inner layer and the intermediate layer;
wherein the additional material is a barrier material, selected from the group comprised of fillers and additives, embedded in the amorphous areas of the polymer material of the intermediate layer and configured to reduce migration of the additives embedded in the amorphous areas of the polymer material of the inner layer.

2. The plastic member according to claim 1, wherein the inner layer, the intermediate layer, and the outer layer are comprised of the same polymer material.

3. The plastic member according to claim 2, wherein the polymer material is a polypropylene random copolymer.

4. The plastic member according to claim 1, wherein the polymer material of the intermediate layer is a polypropylene random copolymer present in the intermediate layer in an amount of 50 to 90 percent by weight, wherein the polypropylene random copolymer has an ethylene contents of 2 to 6 percent by weight and a melt flow rate value of 0.3 to 10 g per 10 minutes at a testing temperature of 190° C. with a 5 kg weight, wherein the barrier material is a glass component present in the intermediate layer in an amount of 10 to 50 percent by weight, wherein the intermediate layer further comprises a bonding agent for bonding the polypropylene random copolymer and the glass component to one another to form the composite material.

5. The plastic member according to claim 4, wherein the amount of the polypropylene random copolymer is 60 to 80 percent by weight.

6. The plastic member according to claim 4, wherein the amount of the glass component is 20 to 40 percent by weight.

7. The plastic member according to claim 4, wherein the glass component is selected from the group consisting of glass fibers, glass beads, glass powder, and mixtures thereof.

8. The plastic member according to claim 4, wherein at least one of the composite material of the intermediate layer and the polymer material of the inner layer contains a processing aid.

9. The plastic member according to claim 8, wherein the processing aid is an internal lubricant.

10. The plastic member according to claim 4, wherein at least one of the composite material of the intermediate layer and the polymer material of the inner layer contains additives selected from the group consisting of light stabilizing compounds and thermal stabilizing compounds.

11. The plastic member according to claim 4, wherein the bonding agent is a silane compound.

12. The plastic member according to claim 1, wherein the polymer material of the inner layer contains a processing aid.

13. The plastic member according to claim 11, wherein the processing aid is an internal lubricant.

14. The plastic member according to claim 1, wherein the polymer material of the outer layer contains an internal lubricant.

15. The plastic member according to claim 1, wherein the polymer material of the inner layer contains additives selected from the group consisting of light stabilizing compounds and heat-stabilizing compounds.

16. The plastic member according to claim 1, wherein the polymer material of the outer layer contains additives selected from the group consisting of light stabilizing compounds and heat-stabilizing compounds.

17. The plastic member according to claim 1 in the form of a pipe, a fitting, or a shaped part.

18. A method for manufacturing the composite material of the intermediate layer of the plastic member according to claim 1, comprising the step of:
mixing in a compounding machine a plasticized polypropylene random copolymer, a glass component, stabilizers, and additives to form a homogenous composite material.

19. The method according to claim 18, wherein the glass component is selected from the group consisting of glass fibers, glass beads, glass powder and mixtures thereof.

20. The method according to claim 19, wherein the glass fibers are glass fibers of an initial length of 0.3 to 6 mm or endless glass fibers comminuted during the step of mixing.

21. The method according to claim 19, wherein the glass fibers have a tex of between 500 and 5,000.
